(19) United States
(12) Patent Application Publication
(10) Pub. No.: US 2009/0296408 A1
(43) Pub. Date: Dec. 3, 2009

(54) LIGHT DISTRIBUTION

(75) Inventors: Bernardus Hendrikus Wilhelmus Hendriks, Eindhoven (NL); Coen Theodorus Hubertus Fransiscus Liedenbaum, Eindhoven (NL); Stein Kuiper, Eindhoven (NL); Fank Jeroen Pieter Schuurmans, Eindhoven (NL); Joseph Ludovicus Antonius Maria Sormani, Eindhoven (NL); Marco Van As, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,819

(22) PCT Filed: Dec. 7, 2005
(86) PCT No.: PCT/IB2005/054105

§ 371 Date: Aug. 4, 2009

(30) Foreign Application Priority Data
Dec. 21, 2004 (EP) 04106765.3

(51) Int. Cl. F21V 5/00

(52) U.S. Cl. 362/311.01

(57) ABSTRACT

An illumination device comprising a light source (2), an electro-wetting based optical element (1, 10), arranged in front of the light source to allow refraction of a beam of light emitted from said light source, and driving means (9) arranged to operate said optical element between at least two predefined states, said states being adapted to result in refracted beams having different light intensity distribution. According to this design, the electrowetting based optical element can be used to dynamically alter the light intensity distribution of the illumination device between a number of predefined states.

The present invention relates to a lighting device with means for altering the light intensity distribution.

Light emitting diodes (LEDs) are increasing introduced in various illumination applications. LEDs can produce various colors, even white light, at high brightness. A clear advantage compared to the conventional lamp bulb is that they are compact and operate at moderate temperatures.

In order to increase the possible applications of LEDs in illumination, the functionality of altering the light distribution is required. An altered light intensity distribution can be desired to change the spot size of the light beam, but can also be required to reshape the typically Gaussian light intensity distribution without altering the spot size. An altered light color distribution may be desired to avoid colorations, i.e. red, green, and blue hues at the rim of the spot that may arise as a result of imperfect color mixing. One example of a static light intensity distribution-converting device is disclosed in US 2002/0067549. This device comprises a glass body having two curved surfaces and can be used, as e.g. a collimator lens or an objective lens, when a more evenly distributed light intensity is required.

There are also various other methods to alter the distribution, for instance by adding moveable parts such as moveable mirror. Such systems require various mechanical parts making them susceptible to wear and making them less robust. Furthermore, these devices are rather expensive.

Therefore, there are presently no satisfactory solutions to providing an illumination device with variable light distribution.

It is an object of the present invention to overcome this problem, and to provide an illumination device with improved means for altering the light intensity and/or color distribution.

This and other objects are achieved by a lighting device comprising a light source and an electro-wetting based optical element, arranged in front of the light source to allow refraction of a beam of light emitted from said light source, and driving means arranged to operate the optical element between at least two predefined states, said states being adapted to result in refracted beams having different light intensity distribution.

According to this design, the electrowetting based optical element can be used to dynamically alter the light intensity distribution of the illumination device between a number of predefined states. The principles and advantages with electrowetting lenses and switches are well documented in the prior art, but such elements have so far mainly been used for imaging and focusing light beams in various optical systems, such as scanners, cameras, etc. It should be noted that there is a significant difference between imaging, on the one hand, where light is focused in a plane in order to provide an image of an object, and illumination, on the other hand, where light from a light source is used to illuminate an area. Light emitted from the illumination device according to the invention is used to illuminate an area, without focusing the light in any particular plane.

Variable light intensity distribution according to the present invention can be employed to achieve reshaping of the light beam, e.g. from a Gaussian distribution to a symmetric, or doughnut shaped distribution. This can be useful e.g. in a light organ to change the ambiance of the surroundings (atmosphere provider). In some applications it may be desirable to temporarily have more light in the center of the spot without making the beam smaller. Such reshaping does not necessarily imply that the angular spread of the light beam is altered, i.e. that the size of the light spot on a fixed observation plane changes. For example a surgeon who wants to focus on a small target during a surgery, without loosing all the light on the outside of the beam, so that he can still keep an eye on the surrounding organs.

However, variable light distribution according to the invention may also be employed to achieve a different angular intensity distribution, or spread, i.e. a variable spot size, either separately or in combination with light reshaping as mentioned above. A variable angular spread can be used e.g. to realize switching between a spot light and a floodlight. In a case where the light source comprises a plurality of colors, e.g. an array of different colored LEDs, undesired coloration effects can be minimized, and an improved color mixing can be achieved by adjusting the angular emission pattern of some or all LEDs.

The optical element can comprise an electro-wetting switch, comprising a beam modifying surface and means for changing a medium covering said surface, and wherein the driving means are arranged to operate the medium changing means between the first state, in which said surface is covered with a first medium, and the second state, in which said surface is covered with a second medium.

Such a switch will provide two distinct states, to be selected by the driving means.

The switch can also have two beam modifying surfaces. The two surfaces can have the same or opposite refracting effect, depending on the application. If both surfaces have the same curvature as seen from the light source, the optical effect will be the opposite (first converging and then diverging or vice versa). Such a switch can be used to provide the reshaping mentioned above. If both surfaces have the opposite curvature as seen from the light source, they will provide the same optical effect.

Alternatively, or in combination, the optical element can comprise an electrowetting lens, and also two lenses arranged in series, in which case the driving means are arranged to operate the lens(es) between at least two predefined states. Just like with the switch mentioned above, lenses with opposite refracting effects can be used to achieve reshaping.

According to one embodiment, the driving means are arranged to continuously alternate between said at least two predefined states, i.e. switch the optical element repeatedly between the states. Such repeated switching can be used to provide a perceived mix of different states, for example a mix of floodlight and spot light. Preferably, the transition time between states is shorter than the retention time of the human eye, resulting in a perceived illumination comprising several different components.

The driving means can further be arranged to adjust the current through the light source in response to the selected state of the optical element. For example, the current can be increased when the angular spread increases, such that the light intensity in a given point is essentially constant.

Preferably, the light source comprises at least one LED. However, any light source having moderate-working temperatures can be used in connection with electro-wetting based optical elements.

This and other aspects of the present invention will now be described in more detail, with reference to the appended drawings showing a currently preferred embodiment of the invention.

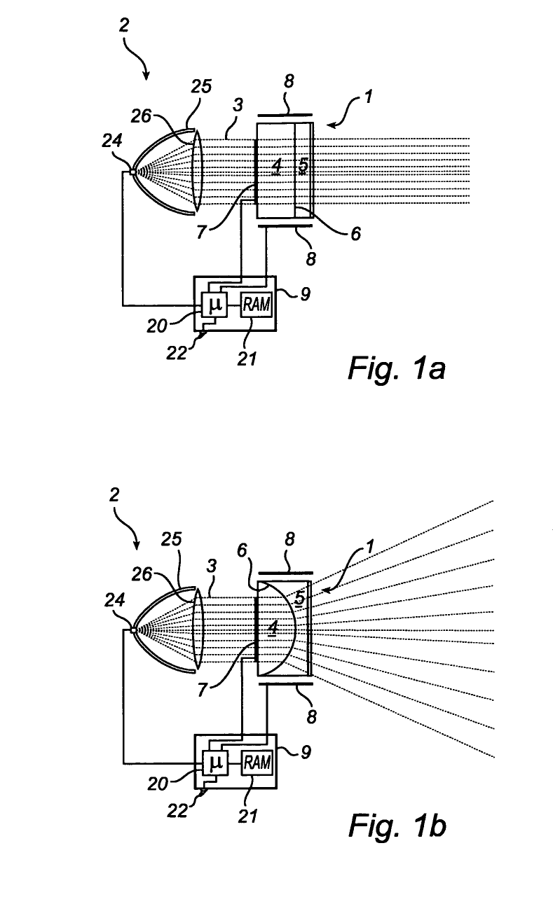

FIG. 1a is a schematic view of a lighting device according to a first embodiment of the invention in a first state.

FIG. 1b is a schematic view of the device in FIG. 1a in a second state.

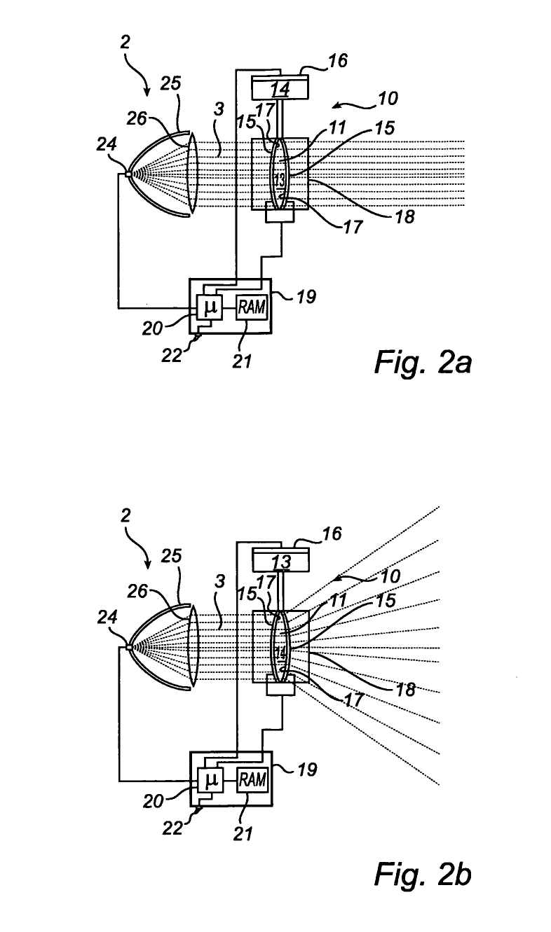

FIG. 2a is a schematic view of a lighting device according to a second embodiment of the invention in a first state.

FIG. 2b is a schematic view of the device in FIG. 2a in a second state.

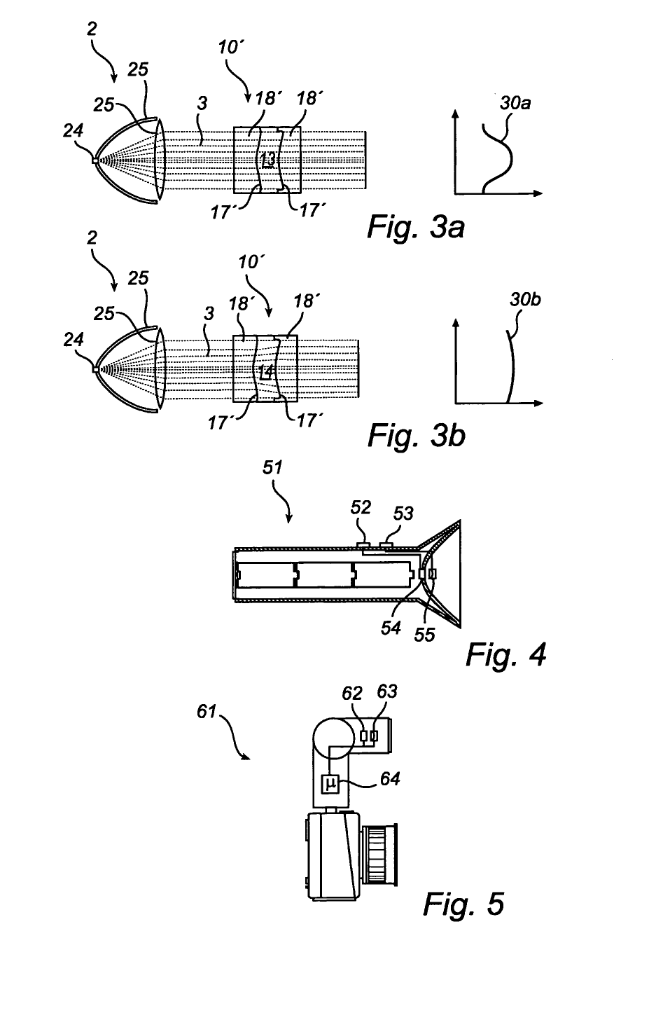

FIG. 3a is a schematic view of a lighting device according to a third embodiment of the invention in a first state.

FIG. 3b is a schematic view of the device in FIG. 3a in a second state.

FIG. 4 is a schematic view of a torch provided with a lighting device according to the invention.

FIG. 5 is a schematic view of a camera flash provided with a lighting device according to the invention.

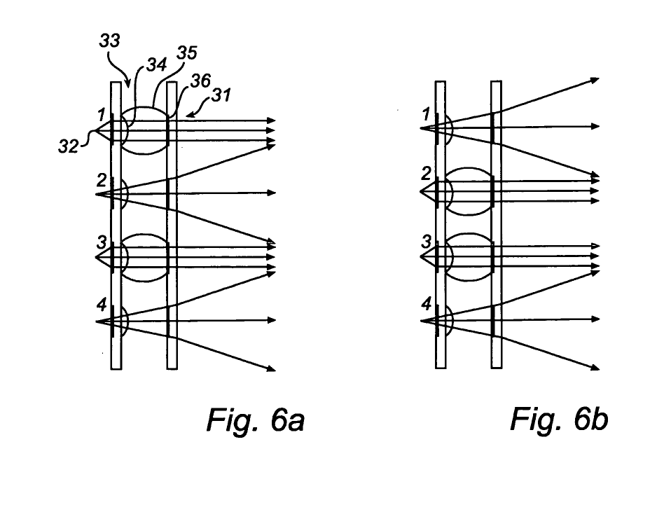

FIGS. 6a and 6b are schematic views of a plurality of optical elements arranged in front of a segmented LED.

FIG. 1a-b show schematically a setup according to a first embodiment of the invention, where an electrowetting lens 1 is arranged after a light source 2. The light source 2 emits a substantially collimated light beam 3, which is transmitted by the lens 1. The lens contains two fluids 4, 5, here water and oil with refractive index of 1.34 and 1.50, respectively, and a meniscus 6 is formed between the two fluids. Electrodes 7, 8 are arranged to allow application of a voltage over the to fluids, to thereby continuously alter the energy equilibrium of the meniscus, thereby changing its curvature. Details of such an electrowetting lens are given in WO03/069380, herewith incorporated by reference. Further, a driver 9 is connected to the electrodes 7, 8, and adapted to operate the lens 1 between at least two separate states. The driver may be arranged either inside or outside the lighting module comprising the LED(s) and the optical element(s).

FIG. 1a shows a first switching state, where the meniscus 6 is flat and the distribution of light beam 3 emitted from the diode 2 is essentially unaltered. FIG. 1b shows a second switching state where the meniscus 6 is concave and approximately half-spherical, thus introducing an angular spread of the beam 3.

According to a setup according to a second embodiment of the invention, shown in FIGS. 2a-b, the lens in FIGS. 1a-b has been replaced with a binary switch 10, of the kind including a fluid system including two cavities 11, 12 filled with fluids 13, 14, and a beam modifying surface 17 arranged in association with one of the cavities so that it can be covered by one of the two fluids (e.g. air and water), thereby resulting in different beam modifying properties. The beam-modifying surface can be an aspherical surface, a grating and/or hologram structure. Electrodes 15, 16 are arranged to allow application of voltages over the surface to thereby effect a switch of mediums by electrowetting. The principles of such an electrowetting switch are given in WO2004/027490, herewith incorporated by reference.

In the example in FIGS. 2a-b the switch comprises two beam-modifying surfaces 17 in order to increase the refraction introduced by the switch. In the example, the beam modifying surfaces are aspherical surfaces facing each other, together forming a cavity 11 in the shape of a pointed ellipse, i.e. a convex lens. The surfaces 17 are formed by the interior walls of two transmissive bodies 18, the exterior walls of which are flat. The bodies 18 can be made by injection molding of plastic such as COC or by glass molding. Further, a driver 19 is connected to the electrodes 15, 16 and adapted to operate the switch 10 between its two states.

FIG. 2a shows a first switching state, where the cavity 11 is filled with oil having substantially the same refractive index as the surrounding walls, and the distribution of light beam 3 emitted from the diode 2 is essentially unaltered. FIG. 2b shows a second switching state where the cavity 11 is filled with water resulting in a refractive index mismatch with the surrounding walls, thus introducing an angular spread of the beam 3. In a third embodiment of the invention, shown schematically in FIGS. 3a-b, an electrowetting switch 10′ has two transmissive bodies 18′, the interior walls of which form two beam modifying surfaces 17′ which have similar curvature seen from the light source 2. As indicated in the figure, the curvature is convex in the center while it becomes concave towards the edges. The curvature can be accomplished by aspherical surfaces, or by gratings, as mentioned above. Apart form the curvature of the interior surfaces 17′, the switch in FIGS. 3a-b has the same design and function as the one in FIGS. 2a-b, and is provided with a driver like in FIGS. 2a-b. No further description of the switch and driver is therefore made here.

In FIG. 3a, the cavity is filled with oil 13, and a light beam 3 emitted from the light source 2 is essentially unaffected by the optical element 10′. In FIG. 3b, where the cavity is filled with water 14, mainly the central part of the light beam 3 will first be divergently refracted, and then again converged. The double refraction will alter the light distribution, e.g. from a Gaussian distribution (schematically indicated by an intensity diagram 30a in FIG. 3a) to a more annular distribution, or a top hat distribution, etc (schematically indicated by diagram 30b in FIG. 3b). Such reshaping may be accomplished in isolation, or in combination with the angular redistribution described above.

The switch in FIGS. 3a-b can also be replaced by two electrowetting lenses in series. Also in this case the optical element will offer double refraction, enabling reshaping of the light without angular redistribution. Normally, the refracting effect of electrowetting lenses is too small to provide adequate reshaping of the light. However, it is possible that sufficient refraction can be accomplished by providing more electrodes.

In FIGS. 1a-b, 2a-b and 3a-b, the light source 2 comprises a single LED 24, a reflector 25, and a collimating lens 26. The skilled person will understand that multiple LEDs may be arranged in the light source, e.g. a combination of red, green and blue LEDs for colored illumination purposes. It should further be understood that the beam 3 has been schematically illustrated. In reality, a beam from a LED is rarely completely collimated, but typically slightly divergent. The extent and position of the reflector 25 is also schematic, and should be understood to possibly reach the lens 1 or 10.

In all the above embodiments, the driver 9, 19 preferably includes a microcontroller 20 and a memory 21 for converting a desired user setting into suitable driving voltages for the optical element. The driver can be provided with a manual switch 22 for allowing a user to select a desired state manually, and thus alter the light distribution.

In case of an optical switch, the voltages required to switch between the two binary states are well defined. In case of an electrowetting lens, the whole range of applicable voltages is divided into intervals by selecting a number of predefined voltage levels, each resulting in significantly different light distribution. In both cases, the different voltages corresponding to different states and light distributions can be preprogrammed in the microcontrollers memory.

For instance, three states can be defined, namely floodlight (state 1), intermediate spot (state 2) and small spot (state 3). Each state is associated with a corresponding voltage, e.g. 0, 24 and 56 Volts, and the relationships are stored in a look-up table. Such a look-up table can be defined and if necessary tuned for the individual LED modules already during manufacturing. In the user scenario a control in the room only has to define which state on would like to have and the translation is being done (through the look-up table) in the LED module.

The look-up table can also include suitable values for current settings for the LED(s), enabling for example an increase in current when the spot size is enlarged. By such current control, the overall perceived brightness can be maintained.

The microcontroller 21 can also be adapted to provide automatic adjustment of the optical element in accordance with the circumstances. For example, the processor can access the look up table, and switch between various predefined light distributions depending on varying ambient light conditions.

The microcontroller 21 may also be adapted to continuously switch between different states. If the optical element is designed in such a way that it has a transition time between different states shorter than the retention time of the human eye, such switching can be effected fast enough so as to allow for mixing of different light distributions so that the different components are indistinguishable for the user. This effect may be enhanced by also adjusting the current through the LEDs.

For example, two light distributions (e.g. flood vs. spotlight) can be combined with time dependent currents through the LEDs. During a first time interval T1 the switch is in the spotlight mode and the current through the LEDs is adjusted to a first value, say I1. Then, during interval T2 the switch is in the floodlight mode and the current is adjusted to a second value I2. If T1 and T2 are well below the retention time of the eye, as described above, and switching between the two states is performed continuously, the human eye will integrate the resulting light pattern and register a floodlight pattern with a certain brightness having a brighter spot therein.

A multitude of atmospheres and effects can be created in this way. Further, it is of course evident that if the light source consists of individually colored LEDs (i.e. R, G and B combined to give white) one cannot only achieve intensity variations in a particular lighting configuration, but also colored settings, for instance a blue floodlight background with a red spot in the middle. Any such pattern can also be made to vary over time, by suitable programming of the processor.

FIG. 4 shows a torch or flash light 51 provided with a light distribution control according to an embodiment of the invention. In addition to an ON/OFF switch 52 for operating a light source 54, such as a LED, the torch comprises an additional switch 53 for operating an electrowetting optical element 55 arranged in front of the LED. The switch 53 can be used for altering the distribution of the emitted light, e.g. for switching between flood-light and spot-light.

FIG. 5 shows a camera flash 61 provided with an embodiment of the invention. An electrowetting optical element 63 is arranged in front of a light source 62, and controlled by a flash microcontroller 64. When taking a photograph of a distant object, a different light distribution is required depending on whether the object is zoomed in or not. For an object not zoomed in, a flood light flash is required to illuminate the whole scene. For a zoomed in object a spot light is more suitable. By providing sufficient concentration of the light (small spot) it will also be possible to acquire satisfactory images of objects even further away.

FIGS. 6a, 6b show a further embodiment of the invention, comprising several optical elements 31 arranged in front of a plurality of separate LEDs 32. The elements can be either electrowetting lenses or switches or combinations thereof. In one example, the optical elements are embodied by a liquid filled compartment 33 and an aspherical surface 34 in front of each LED 32. A number droplets 35 of a second fluid float are contained in the compartment, and can be controlled to positions in front of selected LEDs by addressing electrodes 36. In the illustrated example, for simplicity only four LEDs are depicted, and the fluid contains two droplets. In FIG. 6a these droplets are positioned in front of the first and third LEDs, preventing diversion of the beams from these LEDs. In FIG. 6b, the upper droplet has been shifted down to the second LED.

Such a multiple LED in front of segmented optical element can be used as atmosphere provider, since various light distribution can be created. The LEDs may be colored so that not only the light distribution but also the color distribution can be altered. The driving can be performed by a look up table to switch between various predefined light distributions. It is also possible to use a computer program, which for instance transforms music (sound) into a certain light distribution (atmosphere provider coupled to music).

The person skilled in the art realizes that the present invention by no means is limited to the preferred embodiments described above. On the contrary, many modifications and variations are possible within the scope of the appended claims. For example, the number of lenses and/or switches, as well as the specific design of each lens/switch may be changed, depending on the application and desired result. Further, the electrowetting based optical element can advantageously be combined with the collimator, to form an integrated light source with light intensity distribution capabilities.

1. An illumination device comprising:
a light source (2),
an electro-wetting based optical element (1, 10), arranged in front of the light source to allow refraction of a beam of light emitted from said light source, and
driving means (9, 19) arranged to operate said optical element between at least two predefined states, said states being adapted to result in refracted beams having different light intensity distribution.

2. An illumination device according to claim 1, wherein said optical element (10) is an electro-wetting switch, comprising a beam modifying surface (17) and means (11, 12, 15, 16) for changing a medium covering said surface, and wherein said driving means (19) are arranged to operate said medium changing means between said first state, in which said surface is covered with a first medium, and said second state, in which said surface is covered with a second medium.

3. An illumination device according to claim 2, wherein said electro-wetting switch comprises two beam modifying surfaces (17, 17′).

4. An illumination device according to claim 1, wherein said optical element comprises an electro-wetting lens (1), and wherein said driving means (9) are arranged to operate said lens between at least two predefined states.

5. An illumination device according to claim 4, wherein said optical element comprises two electro-wetting lenses (1), arranged in series.

6. An illumination device according to claim 1, wherein each state is adapted to provide a transmitted beam having different angular intensity distribution.

7. An illumination device according to claim 6, wherein said driving means are arranged to switch the lighting device between flood light or spot light.

8. An illumination device according to claim 1, wherein said driving means (9, 19) are arranged to continuously alternate between said at least two predefined states.

9. An illumination device according to claim 8, wherein the driving means (9, 19) are arranged to alternate between states with a transition time shorter than the retention time of the human eye.

10. An illumination device according to claim 1 wherein the driving means (9, 19) are arranged to adjust the current through the light source in response to the selected state of said optical element.

11. An illumination device according to claim 1, wherein the light source (2) comprises at least one LED (24).

12. Use of an electrowetting based optical element as a light distribution-converting device.
